(19) United States
(12) Patent Application Publication
(10) Pub. No.: US 2022/0379144 A1
(43) Pub. Date: Dec. 1, 2022

(54) Mask with Straw Hole and Plug

(71) Applicant: James Corbett, Wantagh, NY (US)

(72) Inventor: James Corbett, Wantagh, NY (US)

(21) Appl. No.: 17/335,593

(22) Filed: Jun. 1, 2021

(51) Int. Cl. A62B 18/08; A62B 18/02; A41D 13/11

(52) U.S. Cl. CPC A62B 18/086; A62B 18/025; A41D 13/11

(57) ABSTRACT

A face covering with an included straw hole opening that allows people to drink in public without removing the face covering.

### CROSS-REFERENCES TO RELATED APPLICATIONS

This application claims the benefit of provisional application No. 63/034,498 entitled MASK WITH STRAW HOLE AND PLUG, filed Jun. 4, 2020. The provisional application is incorporated in its entirety by reference.

### FIELD OF INVENTION

The present invention relates generally an article of apparel for preventing the transmission of communicable diseases. More specifically, the present invention is directed towards an improved facial covering to prevent the spread of air borne pathogens.

### BACKGROUND OF THE INVENTION

Social distancing and mask wearing are proven protocols for preventing the spread of novel viruses and other highly contagious diseases. Though generally effective, such protocols tend to be disruptive to people's daily lives. People who desire to do daily functions are burdened with the requirement for wearing masks or face covers in public, restaurants, and bars.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

The present invention is directed to a face covering with an included straw hole opening that allows people to drink in public without removing the face covering.

### BRIEF DESCRIPTION OF THE DRAWINGS

The present invention is described in detail below with reference to the attached drawing figures, wherein:

FIG. 1 illustrates an exemplary embodiment in the plug-open configuration.

FIG. 2 illustrates an exemplary embodiment in the plug-closed configuration.

FIG. 3 provide a detail view of an exemplary embodiment adapted to receive a plastic grommet.

FIG. 4A shows an embodiment of a plastic grommet in an open configuration.

FIG. 4B shows an embodiment of a plastic grommet in a folded configuration.

FIG. 5A shows an embodiment of the present invention with a straw inserted.

FIG. 5B shows a side view of FIG. 5A.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

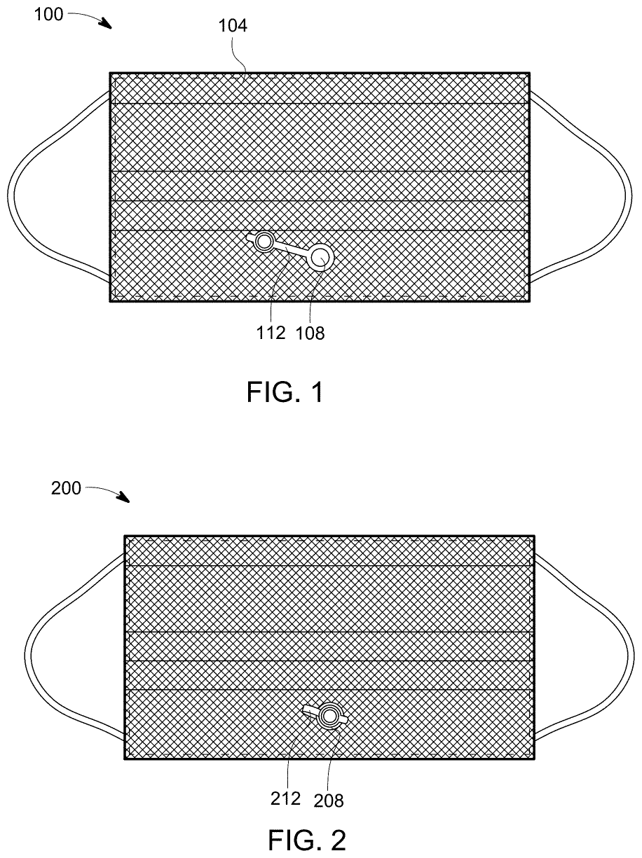

FIG. 1 illustrates an exemplary embodiment in the plug-open configuration 100. As depicted, the mask component 104 comprises a face covering that includes a straw hole opening 108. The placement of the straw hole opening 108 corresponds to the location of the wearers

### BRIEF DESCRIPTION OF THE DRAWINGS

mouth. The straw hole opening 108 may allow the wearer to drink without removing mask component 104. An attached plug 112 is provided such that the straw hole opening 108 may be secured when not in use.

The mask component 104 may be constructed of various materials, including but not limited to, paper, woven cotton fabric, polypropylene spunbond nonwoven fabric, polypropylene melt-blown nonwoven fabric, microfiber nonwoven fabric, or the like or combinations thereof.

FIG. 2 illustrates an exemplary embodiment in the plug-closed configuration 200. As depicted, the attached plug 212 is secured in the straw hole opening 208, providing a protective seal against airborne pathogens.

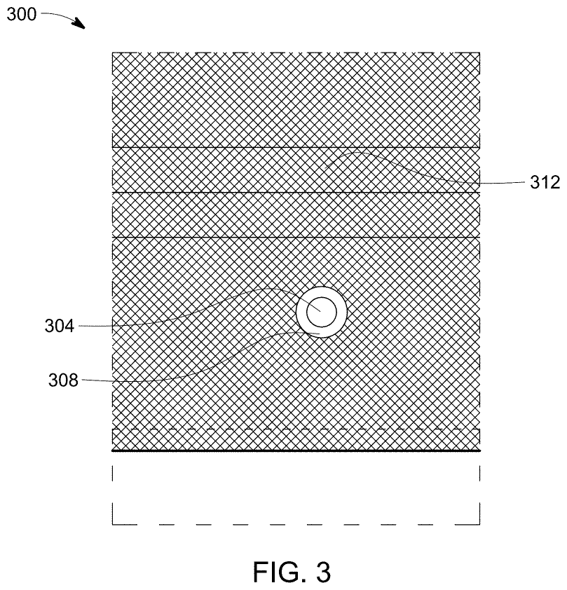

FIG. 3 provide a detail view 300 of an exemplary embodiment adapted to receive a plastic grommet. In some embodiment of the present invention, a straw hole opening 304 may be reinforced, for example, by a thin plastic disc 308 or the like, to provide support, to strengthen the mask component 312, and to prevent the formation of gaps or tears around the straw hole opening 304. Such a reinforcement may be permanently attached to the mask component, and further may serve as a base for a plastic grommet, as shown in FIG. 3.

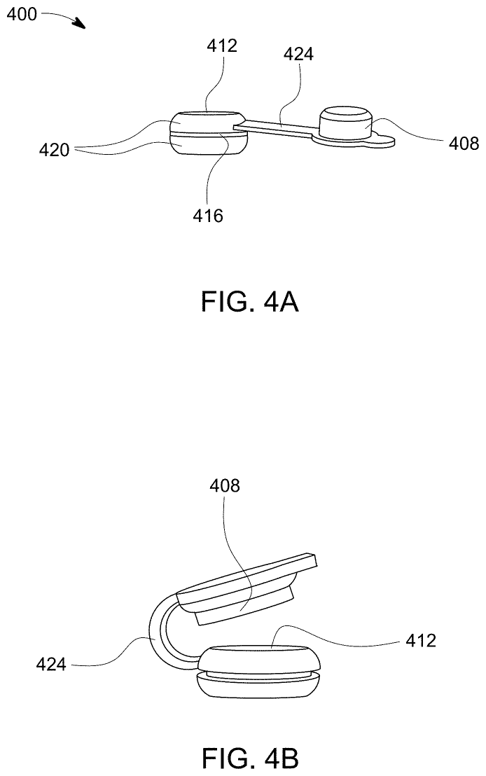

FIG. 4A shows an embodiment of a plastic grommet 404 in an open configuration. The plastic grommet 404 with attached plug 408 that may be inserted into the hole 412. As depicted, the plastic grommet has a groove 416 around its perimeter and a hole 412 thru its center. The groove 416 separates two flanges 420 that surround the groove 416. The groove 416 is designed to receive mask material and the thin plastic disc, discussed in reference to FIG. 3, when the grommet 404 is inserted into the straw hole opening of the mask. The grommet 404 further includes an attached plug 408 that may be sized to fit snuggly in the hole 412. The plug 408 is attached to the grommet with a flexible tether 424.

As depicted in FIG. 4B, the tether 424 can be folded to allow the plug 408 to be inserted into the hole 412 of the grommet.

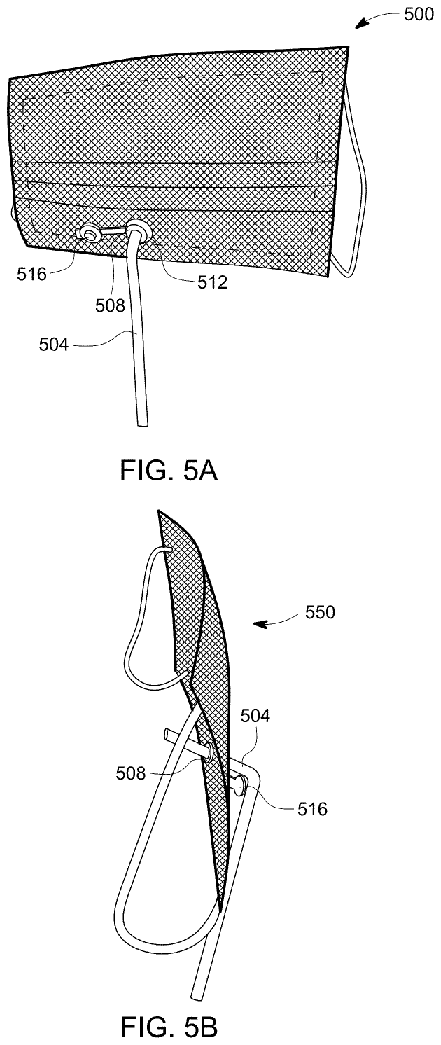

FIG. 5A shows an embodiment of the present invention 500 where a straw 504 is inserted into the hole 508 of the grommet 512, when the plug 516 is removed from the hole 508 of the grommet 512. FIG. 5B shows a side view 550 corresponding to a similar configuration to FIG. 5A.

Further embodiments of the present invention have been conceived. In some embodiments, the present invention may be part of a kit which includes a section of straws design for different contexts. For example, the provided straws may be of various lengths, where each length is better suited for particular drinking vessels. The provided straws may be made of biodegradable material and may be flexible such that they can bend to better accommodate both the mask and the drinking vessel.

In further embodiments, the hole of the grommet may comprise an X-shaped opening, such that it forms a seal when unperturbed, but will give way when a drinking straw is introduced. One with skill in the art will recognize this is similar to how disposable drinking cup lids work to allow a straw to be inserted.

Additional embodiments of the present invention may include a flap opening over the mouth of the wearer, wherein the flap opening may be large enough to allow the wearer to eat through the flap opening. The flap opening may be secured via hook and loop fasteners, such as Velcro when not in use.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

### CROSS-REFERENCES TO RELATED APPLICATIONS

This application claims the benefit of provisional application No. 63/034,498 entitled MASK WITH STRAW HOLE AND PLUG, filed Jun. 4, 2020. The provisional application is incorporated in its entirety by reference.

### FIELD OF INVENTION

The present invention relates generally an article of apparel for preventing the transmission of communicable diseases. More specifically, the present invention is directed towards an improved facial covering to prevent the spread of air borne pathogens.

### BACKGROUND OF THE INVENTION

Social distancing and mask wearing are proven protocols for preventing the spread of novel viruses and other highly contagious diseases. Though generally effective, such protocols tend to be disruptive to people's daily lives. People who desire to do daily functions are burdened with the requirement for wearing masks or face covers in public, restaurants, and bars.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

The present invention is directed to a face covering with an included straw hole opening that allows people to drink in public without removing the face covering.

### BRIEF DESCRIPTION OF THE DRAWINGS

The present invention is described in detail below with reference to the attached drawing figures, wherein:

FIG. 1 illustrates an exemplary embodiment in the plug-open configuration.

FIG. 2 illustrates an exemplary embodiment in the plug-closed configuration.

FIG. 3 provide a detail view of an exemplary embodiment adapted to receive a plastic grommet.

FIG. 4A shows an embodiment of a plastic grommet in an open configuration.

FIG. 4B shows an embodiment of a plastic grommet in a folded configuration.

FIG. 5A shows an embodiment of the present invention with a straw inserted.

FIG. 5B shows a side view of FIG. 5A.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

FIG. 1 illustrates an exemplary embodiment in the plug-open configuration 100. As depicted, the mask component 104 comprises a face covering that includes a straw hole opening 108. The placement of the straw hole opening 108 corresponds to the location of the wearers

### BRIEF DESCRIPTION OF THE DRAWINGS

mouth. The straw hole opening 108 may allow the wearer to drink without removing mask component 104. An attached plug 112 is provided such that the straw hole opening 108 may be secured when not in use.

The mask component 104 may be constructed of various materials, including but not limited to, paper, woven cotton fabric, polypropylene spunbond nonwoven fabric, polypropylene melt-blown nonwoven fabric, microfiber nonwoven fabric, or the like or combinations thereof.

FIG. 2 illustrates an exemplary embodiment in the plug-closed configuration 200. As depicted, the attached plug 212 is secured in the straw hole opening 208, providing a protective seal against airborne pathogens.

FIG. 3 provide a detail view 300 of an exemplary embodiment adapted to receive a plastic grommet. In some embodiment of the present invention, a straw hole opening 304 may be reinforced, for example, by a thin plastic disc 308 or the like, to provide support, to strengthen the mask component 312, and to prevent the formation of gaps or tears around the straw hole opening 304. Such a reinforcement may be permanently attached to the mask component, and further may serve as a base for a plastic grommet, as shown in FIG. 3.

FIG. 4A shows an embodiment of a plastic grommet 404 in an open configuration. The plastic grommet 404 with attached plug 408 that may be inserted into the hole 412. As depicted, the plastic grommet has a groove 416 around its perimeter and a hole 412 thru its center. The groove 416 separates two flanges 420 that surround the groove 416. The groove 416 is designed to receive mask material and the thin plastic disc, discussed in reference to FIG. 3, when the grommet 404 is inserted into the straw hole opening of the mask. The grommet 404 further includes an attached plug 408 that may be sized to fit snuggly in the hole 412. The plug 408 is attached to the grommet with a flexible tether 424.

As depicted in FIG. 4B, the tether 424 can be folded to allow the plug 408 to be inserted into the hole 412 of the grommet.

FIG. 5A shows an embodiment of the present invention 500 where a straw 504 is inserted into the hole 508 of the grommet 512, when the plug 516 is removed from the hole 508 of the grommet 512. FIG. 5B shows a side view 550 corresponding to a similar configuration to FIG. 5A.

Further embodiments of the present invention have been conceived. In some embodiments, the present invention may be part of a kit which includes a section of straws design for different contexts. For example, the provided straws may be of various lengths, where each length is better suited for particular drinking vessels. The provided straws may be made of biodegradable material and may be flexible such that they can bend to better accommodate both the mask and the drinking vessel.

In further embodiments, the hole of the grommet may comprise an X-shaped opening, such that it forms a seal when unperturbed, but will give way when a drinking straw is introduced. One with skill in the art will recognize this is similar to how disposable drinking cup lids work to allow a straw to be inserted.

Additional embodiments of the present invention may include a flap opening over the mouth of the wearer, wherein the flap opening may be large enough to allow the wearer to eat through the flap opening. The flap opening may be secured via hook and loop fasteners, such as Velcro when not in use.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. An improved face covering, comprising:
a mask component;
a straw hole opening through the mask component,
the straw hole opening corresponding to the location of a wearer's mouth;
an attached plug,
the attached plug being configured to secure the straw hole opening when not in use.

2. The improved face covering of independent claim 1, wherein:
the mask component comprises at least one of paper, woven cotton fabric, polypropylene spunbond nonwoven fabric, polypropylene melt-blown nonwoven fabric, and microfiber nonwoven fabric.

3. The improved face covering of independent claim 1, wherein:
the straw hole opening is reinforced with a thin plastic disc.

4. The improved face covering of independent claim 1, further comprising:
a grommet configured to fit securely in the straw hole opening,
wherein the grommet includes a hole configure to accept a drinking straw, and
wherein the attached plug is secured to the grommet by a tether.

5. The improved face covering of claim 4, wherein:
the hole of the grommet comprises an x-shaped opening,
wherein the x-shaped opening seal when unperturbed, and
wherein the x-shaped opening gives way when the drinking straw is introduced.

6. An improved face covering, comprising:
a mask component;
a flap opening,
the flap opening corresponding to the location of a wearer's mouth;
a hook and loop fastener,
wherein the hook and loop fastener can secure the flap opening close when not in use.
